(19) United States
(12) Patent Application Publication
(10) Pub. No.: US 2013/0164204 A1
(43) Pub. Date: Jun. 27, 2013

(54) SOLVENT COMPOSITION FOR CARBON DIOXIDE RECOVERY

(71) Applicant: Prateek Bumb, Jaipur (IN)

(72) Inventor: Prateek Bumb, Jaipur (IN)

(73) Assignee: Carbon Clean Solutions Pvt. Ltd., Banglore (IN)

(21) Appl. No.: 13/820,995

(22) PCT Filed: Sep. 16, 2011
(86) PCT No.: PCT/IB11/54062

§ 371 Date: Mar. 5, 2013

(30) Foreign Application Priority Data
Sep. 20, 2010 (IN) 2238/DEL/2010

(51) Int. Cl. C09K 3/00

(52) U.S. Cl. CPC C09K 3/00
USPC 423/232; 252/364

(57) ABSTRACT

The present disclosure provides for a solvent composition for recovery of carbon dioxide from gaseous mixture, comprising diethanolamine, piperazine or its derivative, alkali salt, optionally along with cupric carbonate. The disclosure relates to improved solvent formulations that utilizes less energy and increased carbon capture efficiency. The disclosure also addresses the high CO₂ loading capacity and energy requirement over the existing carbon dioxide capture solvent.

### TECHNICAL FIELD

The present disclosure relates to a solvent composition for recovering carbon dioxide from gaseous mixture. More particularly, the disclosure relates to improved solvent formulations that utilizes less energy and increased carbon capture efficiency. The disclosure also addresses the high CO₂ loading capacity and energy requirement over the existing carbon dioxide capture solvent.

### BACKGROUND

Carbon dioxide (CO₂) is a major Greenhouse gas responsible for global warming, and hence, much effort is being put on the development of technologies for its capture from process gas streams (e.g., flue gas, natural gas, coke oven gas and refinery off-gas).

Carbon dioxide is emitted in large quantities from large stationary sources. The largest single sources of carbon dioxide are conventional coal-fired power plants. Technology developed for such sources should also be applicable to CO₂. capture from gas and oil fired boilers, combined cycle power plants, coal gasification, and hydrogen plants. Absorption/stripping are primarily a tail-end technology and are therefore suitable for both existing and new boilers. The use of absorption and stripping processes for recovery of the carbon dioxide from the gaseous mixture is known in the art. The conventional carbon capture process consists of an absorber column, a stripper column and compression unit. Gaseous mixture enters the absorber where it comes in contact with the solvent. The rich stream leaving the absorber has carbon dioxide trapped in solvent composition. The captured carbon dioxide is stripped in the stripper column with the help of steam energy provided by the reboiler. The overhead stream from the stripper is condensed and the condensate is passed back to the stripper while the gaseous stream, rich in carbon dioxide is compressed and sent for the suitable applications.

The major drawback of conventional carbon capture system is that the high energy is needed to strip the carbon dioxide from the rich solvent. Steam of higher pressure is required to strip the carbon dioxide and thus stripper reboiler and compressor account for major derating of the industrial unit.

Further, a number of different CO₂ separation technologies are available, absorption performed with chemical solvents representing the most feasible option. In such operations, alkanolamine-based absorbents and their blends are extensively applied. Industrially important alkanolamines for CO₂ removal are the primary amine, the secondary amine and the tertiary amine. The invention addresses the high CO₂ loading capacity and energy requirement over the existing carbon dioxide capture solvent. The disadvantage with the conventional solvent is that the system requires more energy.

Conventional solvent has several disadvantages with the treating gaseous mixture such as chemical degradation, thermal degradation and corrosivity.

In light of foregoing discussion, it is necessary to develop a system which consumes less energy for recovering the carbon dioxide from the gaseous mixture. And also to provide an improved solvent formulations that seek to overcome the obstacles associated with the conventional solvent system and reduce the energy requirement in the whole capture process.

### SUMMARY OF THE DISCLOSURE

An embodiment of the present disclosure relates to a solvent composition for recovery of carbon dioxide from gaseous mixture, comprising diethanolamine, piperazine or its derivative, alkali salt, optionally along with cupric carbonate.

In an embodiment of the disclosure, the amine is selected from group comprising Monoethanolamine (MEA), Diethanolamine (DEA), Triethanolamine (TEA), Dimethylethanolamine (DMEA), N-methyldiethanolamine (MDEA), Monomethylethanolamine (MMEA), 2-(2-aminoethoxy)ethanol, Aminoethylethanolamine (AEEA), Ethylenediamine (EDA), Diethylenetriamine (DETA), Triethylenetetramine (TETA), Tetraethylenepentamine (TEPA), 2-amino-2methyl-1 -proponal (AMP), 2-(ethyamino)-ethanol (EAE), 2-(methylamino)-ethanol (MAE), 2-(diethylamino)-ethanol (DEAE), diethanolamine (DEA), diisopropanolamine (DIPA), methylaminopropylamine (MAPA), 3-aminopropanol (AP), 2,2-dimethyl-1,3-propanediamine (DMPDA), 3-amino-1-cyclohexylaminopropane (ACHP), diglycolamine (DGA), 1-amino-2-propanol (MIPA), 2-methyl-methanolamine (MMEA) or any combinations thereof, preferably N-methyl diethanolamine, at concentration ranging from about 10 wt % to about 50 wt %.

In an embodiment of the disclosure, the piperazine derivative is selected from group comprising N-aminoethylpiperazine (AEP), N-methylpiperazine, 2-methylpiperazine, 1-ethylpiperazine, 1-(2-hydroxyethyl)piperazine, 1,4-dimethylpiperazine or any combinations thereof, preferably piperazine, at concentration ranging from about 0.5 wt % to about 50 wt % or N-methyl piperazine at concentration ranging from about 0.5 wt % to about 50 wt %.

In an embodiment of the disclosure, the alkali salt is selected from a group comprising potassium carbonate, sodium carbonate salt, lithium carbonate, a bicarbonate salt, a bisulfide salt, hydroxide salt or any combination thereof, preferably potassium carbonate and a bicarbonate salt, at concentration ranging from about 2 wt % to about 25 wt %.

In an embodiment of the disclosure, the cupric carbonate is at concentration ranging from about 50 ppm to 300 ppm.

### BRIEF DESCRIPTION OF ACCOMPANYING FIGURES

In order that the disclosure may be readily understood and put into practical effect, reference will now be made to exemplary embodiments as illustrated with reference to the accompanying figures. The figure together with a detailed description below, are incorporated in and form part of the specification, and serve to further illustrate the embodiments and explain various principles and advantages, in accordance with the present disclosure where:

FIG. 1 shows experimental set-up for stirred cell reactor.

FIG. 2 shows experimental set up for Vapor liquid Equilibrium

FIG. 3 shows experimental results and Model predicted equilibrium partial pressure of CO₂ above aqueous 20 wt % K₂CO₃ solution at different temperatures.

FIG. 4 shows experimental results and Model predicted equilibrium partial pressure of CO₂ above aqueous 30 wt % K₂CO₃ solution at different temperatures.

FIG. 5 shows Equilibrium partial pressure of CO₂ over aqueous mixtures of (MDEA+PZ).

FIG. 6 shows ENRTL model predicted equilibrium CO2 partial pressure over (4.081 m MDEA+0.653 m K₂CO₃+0.147 m KHCO₃+0.408 m PZ) in the temperature range of (313-333) K.

FIG. 7 shows ENRTL model predicted activity coefficients of species in liquid phase of a (4.081 m MDEA+0.653 m K₂CO₃+0.147 m KHCO₃+0.408 m PZ) solvent loaded with CO₂ at 313 K.

FIG. 8 shows ENRTL model predicted equilibrium liquid phase concentration of different species of a (4.081 m MDEA+0.653 m K₂CO₃+0.147 m KHCO₃+0.408 m PZ) solvent loaded with CO₂ at 323 K.

FIG. 9 shows ENRTL model predicted pH of a (4.081 m MDEA+0.653 m K₂CO₃+0.147 m KHCO₃+0.408 m PZ) solvent loaded with CO₂ at different temperatures.

FIG. 10 shows ENRTL model predicted equilibrium amine partial pressure (amine volatility) of a (4.081 m MDEA+0.653 m K₂CO₃+0.147 m KHCO₃+0.408 m PZ) solvent loaded with CO₂ at different temperatures.

FIG. 11 shows ENRTL model predicted specific heat of the mixture of a (4.081 m MDEA+0.653 m K₂CO₃+0.147 m KHCO₃+0.408 m PZ) solvent loaded with CO₂ at different temperatures.

FIG. 12 shows ENRTL model predicted equilibrium liquid phase concentration (mol/kg water) of different species of a (4.081 m MDEA+0.653 m K₂CO₃+0.147 m KHCO₃+0.408 m PZ) solvent loaded with CO₂ at 323 K.

FIG. 13 shows differential Heat of Absorption (−ΔH_{abs}) vs loading of APBS1 Solvent.

FIG. 14 shows differential Heat of Absorption (−ΔH_{abs}) vs loading (between 0.2 to 0.6) of APBS1 Solvent.

FIG. 15 shows equilibrium CO₂ partial pressure over MDEA-MPZ-K₂CO₃—KHCO₃—H₂O blend at temperature 25 ° C.

FIG. 16 shows literature Comparison with (CO₂+MDEA) and (CO₂+MDEA-MPZ-K₂CO₃—KHCO₃).

FIG. 17 shows a process flow diagram of conventional carbon capture system.

### DETAILED DESCRIPTION OF THE DISCLOSURE

The proposed solvent mixture provides faster CO₂ absorption rates and greater capacity for CO₂ and exhibit lower heat of CO₂ desorption. The lower heat of CO₂ desorption decreases the reboiler steam requirements. The faster absorption kinetics creates richer solutions given the same absorber capital costs. The proposed solvent mixture composition has 10 wt % to 50 wt % N-methyldiethanolamine, 0.5% to 50 wt % piperazine or its derivatives, 2 wt % to 25 wt % alkali salts and optionally with cupric carbonate.

In the present disclosure, kinetics of the CO₂ reaction with MDEA +piperazine (PZ)+K₂CO₃+KHCO₃+H₂O mixture is investigated. Besides, PZ is replaced by another promoter, viz. N-methyl piperazine (MPZ) and the reaction kinetics is investigated using the formulated aqueous solution, viz. MDEA+MPZ+K₂CO₃+KHCO₃+H₂O. Due to its tertiary amine characteristics, MDEA has high CO₂ removal capacity. Although potassium carbonate has low reactivity with CO₂, it has low regeneration cost. PZ and MPZ, which is a cyclic diamine, are used as a promoter.

In an embodiment of the present disclosure, the technology of the instant Application is further elaborated with the help of following examples. However, the examples should not be construed to limit the scope of the disclosure.

### ABBREVIATIONS USED

| | |
|---|---|
| MDEA | N-methyldiethanolamine |
| MPZ | n-Methyl Piperazine |
| PZ | Piperazine |
| APBS | Amine promoted buffer solvent |
| K₂CO₃ | Potassium carbonate |
| KHCO₃ | Potassium bicarbonate |
| VLE | Vapor liquid equilibrium |
| ρ | Density |
| M | Viscosity |
| D_{CO2} | Diffusivity |
| H_{CO}₂ | Solubility |
| k_{obs} | Observed rate constant |
| α_{co2} | Loading |
| P_{CO2} | Partial pressure of carbon dioxide |
| ΔH_{abs} | Heat of absorption |

### EXAMPLE 1

### Characterization of the Solvent System

The conventional CO₂ capture solvents has several disadvantages with the treating flue gas such as chemical degradation, thermal degradation, corrosivity, high capital and operating expenditure. This invention relates the improved solvent formulations that seek to overcome the obstacles associated with the conventional solvent system. The solvent formulation refers to a mixture of solvent with specific concentration for each component. The proposed solvent mixture provides faster CO₂ absorption rates, greater capacity for CO₂ and exhibit lower heat of CO₂ desorption. The lower heat of CO₂ desorption can decrease the reboiler steam requirements. The faster absorption kinetics can create richer solutions given the same absorber capital costs.

Experimental Setup for Stirred Cell Reactor

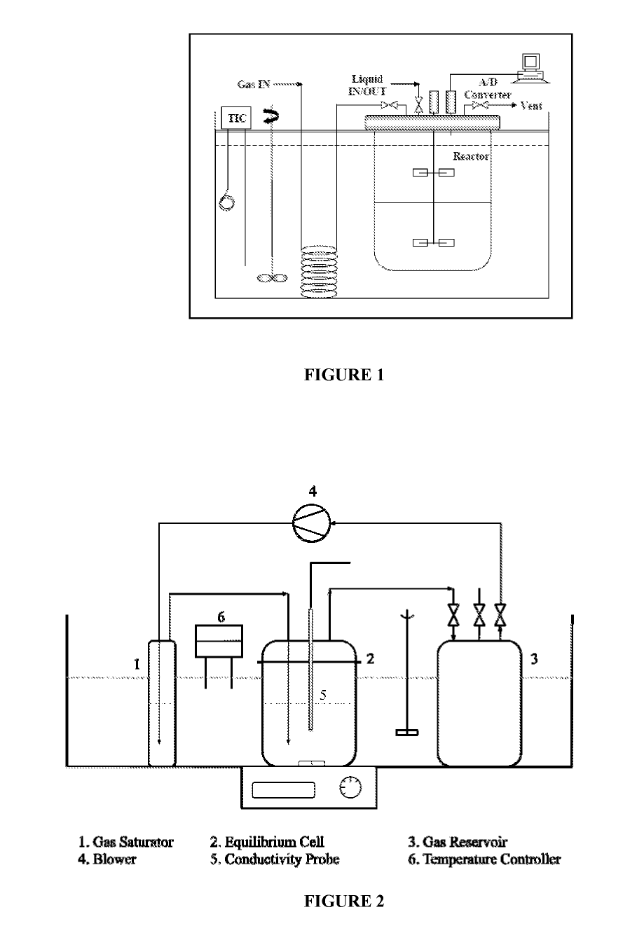

A glass stirred cell reactor with a plane, horizontal gas-liquid interface was used for the absorption studies (see FIG. 1). The main advantage of the stirred cell is that the rates of absorption can be measured using a liquid with a single, known composition. This easy-to-use experimental device (inner diameter 97 mm, height 187 mm) is operated batch wise. The total volume of the reactor is 1.45 dm³ and the interfacial surface area is 7.5×10⁻³ m². The reactor is equipped with a flange made of stainless steel. A pressure transducer (Trans Instruments, UK, 0-1 bar), mounted on this flange and coupled with a data acquisition system, enabled measurement of the total pressure inside the reactor, the uncertainty in this measurement being ±1 mbar. The reactor is also equipped with inlet and outlet ports for the gas and liquid phases. The entire assembly is proven to have no leak. The setup is supplied by a variable speed magnetic drive. The gas and liquid are stirred by two impellers, mounted on the same shaft. The speed of stirring could be adjusted to the desired value with an accuracy of ±1 rpm. The impeller speed during kinetic measurements is limited to 60 rpm, in order to ensure that the gas-liquid interface is undisturbed. The reactor is immersed in a water bath to guarantee isothermal conditions. The temperature is adjusted to the desired value with an accuracy of ±0.1 K. The solute gas passed through a coil, also kept in the water bath, before being charged inside the reactor.

Experimental Procedure on Stirred Cell Reactor

In each experiment, the reactor is charged with 0.4 dm³ of the absorbent. The gas inside the reactor is then purged with N₂ to ensure an inert atmosphere. Thereafter, N₂ is released through the gas outlet port. All the lines are closed and the reactor content attained the desired temperature. CO₂ from the gas cylinder is then charged inside the reactor, this being considered as the starting point for the reaction. The reactor content is stirred at the desired speed of agitation. The decrease in system pressure due to reaction is monitored by the pressure transducer and the “P_{CO}_{₂} vs. t” data are recorded during 30 seconds using the data acquisition system. These data are plotted for the time interval between t=5 s and t=25 s and fitted to a third degree polynomial using the least-square regression. The absorption rates are calculated from the values of the slope −dP_{CO}_{₂}/dt. This measurement method based on the fall-in-pressure technique enabled a simple and straightforward estimation of the absorption rates. Further, no analysis of the liquid phase is required and the pressure decrease is the only factor necessary for the evaluation of the kinetic parameters. In the range of agitation speeds studied, the mass transfer rate is independent of the gas-side mass transfer coefficient, k_{G}. Therefore, the CO₂ absorption process is liquid-phase-controlled. The stirred-cell reactor is also used for measuring N₂O solubility in the aqueous mixtures. To measure solubility, the reactor content is stirred at high agitation speed (˜1000 rpm) for 6 h to ensure that equilibrium is attained. Using the recorded values of the initial and final pressure, the solubility is determined. The reproducibility of results is checked and the error in all experimental measurements is found to be less than 3%.

The density and viscosity of the aqueous blend comprising MDEA, K₂CO₃,KHCO₃, promoter (viz. piperazine and N-methyl piperazine) are measured at 298, 303 and 308 K using a commercial densitometer and Ostwald viscometer, respectively. From viscosity measurements, the values of the N₂O diffusivity in the activated solutions by using the modified Stokes-Einstein correlation:

(D_{N}_{₂}_{O}μ^{0.80})_{Amine}=const=(D_{N}_{₂}_{O}μ^{0.80})_{Water}

The values of D_{CO}_{₂} solutions are found using the N₂O analogy. It states that, at any given temperature, the ratio of the diffusivities of N₂O and CO₂ in amine solution is equal to that ratio in water.

$${( \frac{{D}_{{N}_{2} O}}{{D}_{{CO}_{2}}} )}_{Amine} = {( \frac{{D}_{{N}_{2} O}}{{D}_{{CO}_{2}}} )}_{Water}$$

N₂O solubility in amine blends is estimated. The CO₂ solubility in solution is estimated using the N₂O analogy as follows:

$${( \frac{{H}_{{N}_{2} O}}{{H}_{{CO}_{2}}} )}_{Amine} = {( \frac{{H}_{{N}_{2} O}}{{H}_{{CO}_{2}}} )}_{Water}$$

Formulae Used for Diffusivity (m²/s) Measurement:

$${D}_{{N}_{2} O} = 5.07 \times {10}^{- 6} exp ( - \frac{2371}{T} )$$

$${D}_{{CO}_{2}} = 2.35 \times {10}^{- 6} exp ( - \frac{2119}{T} )$$

Experimental Set-Up and Experimental Procedure for Vapor Liquid Equilibrium

The experimental set-up (FIG. 2, consisted of a gas saturator or gas bubbler, equilibrium cell and gas reservoir). The equilibrium cell, in which the gas-liquid equilibrium is allowed to attain, is fitted with magnetic stirrer to enhance the equilibrium process. Conductivity probe is inserted in equilibrium cell to ensure attained gas-liquid equilibrium. The exit of the cell is connected to a glass reservoir. The gas circulating blower is used to circulate gas in the system. It took gas from reservoir and bubbled in gas saturator. The pressure maintained in the system is practically near atmosphere. The entire assembly is placed in constant temperature bath except gas circulating blower. Since the temperatures are not widely different from ambient 303 K, the heat loss from blower to surrounding can safely be neglected. FIG. 4 shows the complete experimental set-up.

A known quantity of solvent solution is taken in an equilibrium cell. CO₂ gas is injected into reservoir to get the desired partial pressure. The gas circulating blower is then started. Some CO₂ would get absorbed into solvent solution. To compensate this, an additional quantity of CO₂ gas is injected so that system is near atmospheric pressure. The approach to equilibrium is monitored with the help of conductivity probe. Since the reaction of CO₂ with aqueous solvent solution is ionic in nature, the concentration of ionic species remains constant after reaching equilibrium. The constant reading of conductivity probe over two-three days suggests that equilibrium is achieved. At this stage, the gas composition is identical in cell as well as in gas reservoir.

The reservoir is then isolated from the system with the help of valves. A known quantity of caustic, which is in far excess, than required, is added to the reservoir with the help of a gas syringe. It is the well mixed by shaking and kept for 48 h, so that entire amount of CO₂ gas is absorbed into aqueous NaOH solution. A sample is taken from the reservoir with the help of gas tight syringe and introduced into caustic solution to convert it into Na₂CO₃. With the help of CO₂ ion-selective electrode, both samples are analyzed for carbonate, hence CO₂ content is back calculated both is gas phase and in liquid phase.

### EXAMPLE 2

### CO₂-MDEA-PZ-K₂CO₃—KHCO₃—H₂O System

Promoted amines/carbonate blends are potentially attractive solvents for CO₂ capture, and may be recommended for flue gas cleaning. In the present disclosure, the CO₂ reaction with MDEA+PZ+K₂CO₃+KHCO₃+H₂O mixture is investigated. Due to its tertiary amine characteristics, MDEA has high CO₂ removal capacity. Although potassium bicarbonate has low reactivity with CO₂, it has low regeneration cost. Piperazine (PZ), which is a cyclic diamine, is used as a promoter.

The CO₂ reaction with promoted amines/carbonate blend is investigated over the ranges in temperature, 298 to 308 K and PZ concentrations, 0.15 to 0.45 M. The concentrations of MDEA, K₂CO₃ and KHCO₃ in solution are 2.5, 0.4 and 0.09 M, respectively. In the fast reaction regime, the rate of absorption is independent of the liquid-side mass transfer coefficient and hence it should not depend on the agitation speed. Experimentally there is no change in the absorption rate, while varying the stirring speed in the range 50-90 rpm at 308 K. Hence, it can be concluded that the investigated system belongs to the fast reaction regime systems.

a) Estimation of Physical Properties for MDEA-PZ-K₂CO₃—KHCO₃—H₂O Blends

Knowledge on physical properties is essential for the estimation of reaction kinetics. The density and viscosity of the blend comprising MDEA, K₂CO₃, KHCO₃, promoter (piperazine) and H₂O are measured at 298 K, 303 K and 308 K.

MIX*=MDEA (2.5 M), KHCO₃ (0.09M), K₂CO₃ (0.4 M) and Piperizine

Density (ρ), Viscosity (μ) and Diffusivity Data (D_{CO2}) for MIX*:

TABLE 1
Density (ρ), Viscosity (μ) and Diffusivity Data (D_{CO2}) for
MIX* at different Piperazine concentration, at 298, 303 and 308 K.

| T | PZ Conc. | ρ | μ | D_{CO}_{₂} × 10⁹ |
|---|---|---|---|---|
| (K.) | (M) | (kg/m³) | (mPa · s) | (m²/s) |
| 298 | Mix + 0.15 | 1059.12 | 1.53 | 1.312 |
| | Mix + 0.25 | 1071.08 | 1.62 | 1.249 |
| | Mix + 0.35 | 1082.26 | 1.70 | 1.202 |
| | Mix + 0.45 | 1092.79 | 1.80 | 1.149 |
| 303 | Mix + 0.15 | 1058.37 | 1.25 | 1.581 |
| | Mix + 0.25 | 1070.23 | 1.36 | 1.484 |
| | Mix + 0.35 | 1081.07 | 1.46 | 1.398 |
| | Mix + 0.45 | 1091.00 | 1.58 | 1.316 |
| 308 | Mix + 0.15 | 1057.04 | 1.10 | 1.831 |
| | Mix + 0.25 | 1069.38 | 1.18 | 1.721 |
| | Mix + 0.35 | 1079.84 | 1.25 | 1.651 |
| | Mix + 0.45 | 1088.21 | 1.35 | 1.549 |

b) Reaction Kinetic Data for MDEA-PZ-K₂CO₃—KHCO₃—H₂O Blends

With increase in temperature & promoter concentration cause the expected increase in the values of the observed reaction rate constants.

Mix*=MDEA (2.5 M), KHCO₃ (0.09M), K₂CO₃ (0.4 M) and Piperizine.

k_{obs}=r/(CO₂)=observed reaction rate constant (1/s).

TABLE 2
Observed reaction rate constant for Mix* at different piperazine
concentration at 298, 303 and 308 K.

| T | PZ Conc. | k_{obs} |
|---|---|---|
| (K) | (M) | (1/sec) |
| 298 | Mix + 0.15 | 4787 |
| | Mix + 0.25 | 11371 |
| | Mix + 0.35 | 15159 |
| | Mix + 0.45 | 16675 |
| 303 | Mix + 0.15 | 6253 |
| | Mix + 0.25 | 15569 |
| | Mix + 0.35 | 24703 |
| | Mix + 0.45 | 29292 |
| 308 | Mix + 0.15 | 9829 |
| | Mix + 0.25 | 19915 |
| | Mix + 0.35 | 23370 |
| | Mix + 0.45 | 36394 |

TABLE 3
The effect of CO₂ partial pressure on the absorption rates
into aqueous mixtures of MDEA (2.5M), PZ, K₂CO₃ (0.4M)
and KHCO₃ (0.09M) at 298, 303 and 308 K

| Temp. | CO₂ pressure | PZ | R × 10⁶ |
|---|---|---|---|
| (K) | (kPa) | (M) | (kmol/(m² s)) |
| 298 | 8.57 | 0.15 | 7.32 |
| | 8.16 | 0.25 | 10.8 |
| | 7.05 | 0.35 | 11.2 |
| | 3.37 | 0.45 | 5.71 |
| 303 | 6.92 | 0.15 | 5.81 |
| | 8.64 | 0.25 | 11.8 |
| | 6.77 | 0.35 | 12.3 |
| | 12.64 | 0.45 | 25.8 |
| 308 | 8.1 | 0.15 | 8.84 |
| | 6.03 | 0.25 | 9.84 |
| | 9.08 | 0.35 | 17.0 |
| | 13.04 | 0.45 | 31.6 |

TABLE 4
Kinetic and thermodynamic characteristics of mixture
(MDEA = 2.5M, PZ = 0.25M, K₂CO₃ = 0.4M and KHCO₃ = 0.09M)

| | CO₂ | R × 10⁶ | |
|---|---|---|---|
| | Pressure | kmol/ | k_{obs} |
| Temp K | kPa | (m²s) | 1/s |
| 298 | 8.16 | 10.8 | 11371 |
| 303 | 8.64 | 11.8 | 15569 |
| 308 | 6.03 | 9.84 | 19915 |

c) Solubility Data for MDEA-PZ-K₂CO₃—KHCO₃—H₂O Blends

Knowledge on CO₂ solubility in solution is essential for estimation of reaction kinetics.

TABLE 5
Solubility of CO₂ in the mixture [MDEA (2.5M) + K₂CO₃ (0.4M) +
KHCO₃ (0.0925M) + PZ] at 298, 303 and 308 K

| T | PZ Conc. | H_{CO}_{₂} × 10⁴ |
|---|---|---|
| (K) | (M) | [kmol/(m³ · kPa)] |
| 298 | Mix + 0.15 | 3.49 |
| | Mix + 0.25 | 3.51 |
| | Mix + 0.35 | 3.65 |
| | Mix + 0.45 | 3.71 |
| 303 | Mix + 0.15 | 2.76 |
| | Mix + 0.25 | 2.84 |
| | Mix + 0.35 | 2.99 |
| | Mix + 0.45 | 3.10 |
| 308 | Mix + 0.15 | 2.65 |
| | Mix + 0.25 | 2.79 |
| | Mix + 0.35 | 2.96 |
| | Mix + 0.45 | 3.06 |

d) Vapour—Liquid Equilibrium Data for MDEA-PZ-K₂CO₃,—KHCO₃—H₂O Blend.

Knowledge of the equilibrium partial pressure of CO₂ over alkanolamine solution is essential, particularly in the design of top portion of absorber. The CO₂ slip in treated gas is mainly depends on equilibrium partial pressure. Under design of absorber will effect on production cost. Therefore, gas-liquid equilibrium data is of importance.

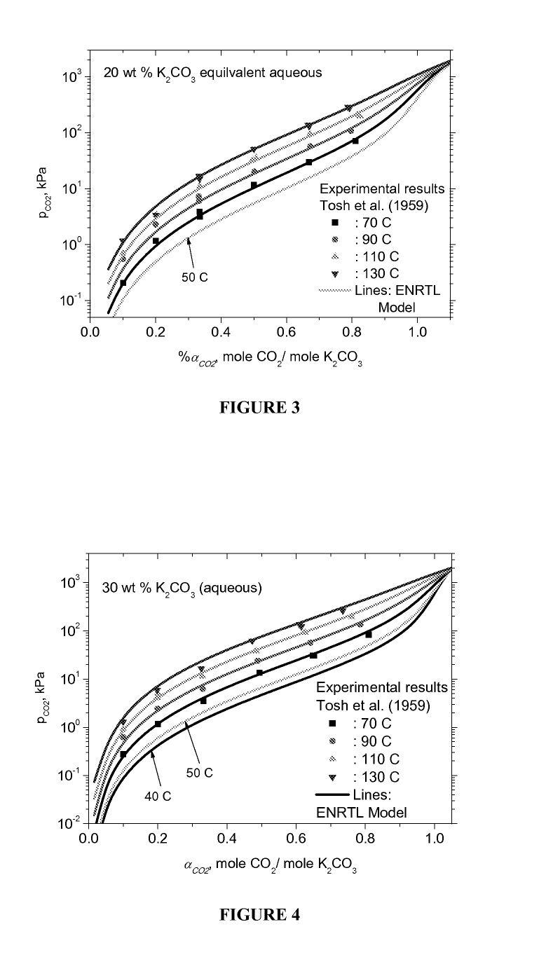

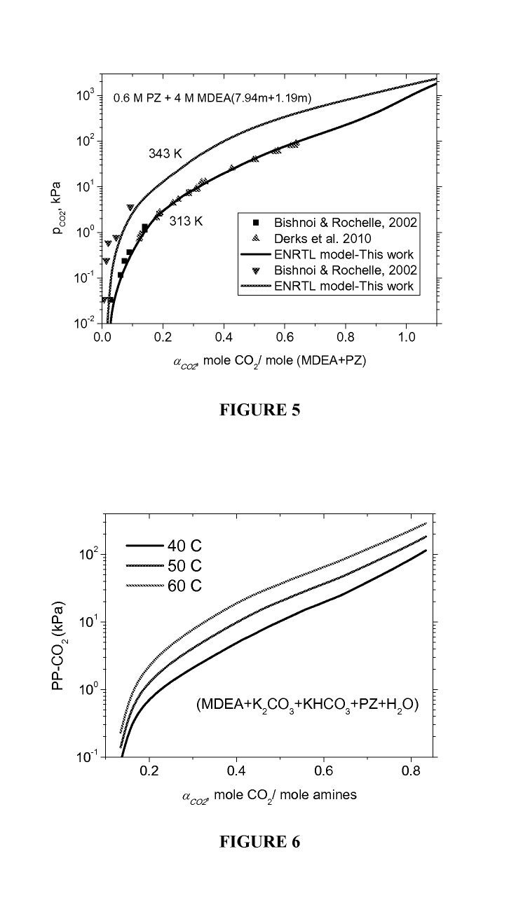

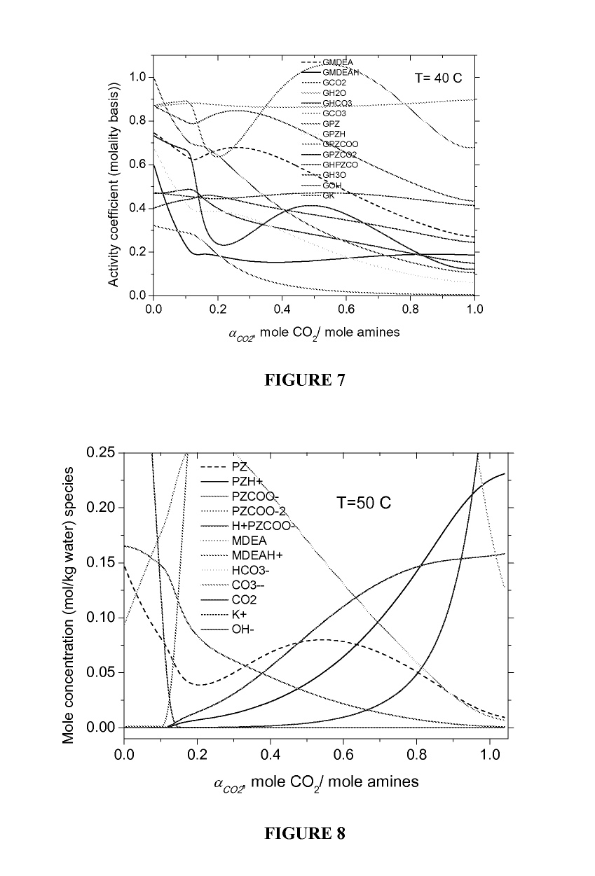

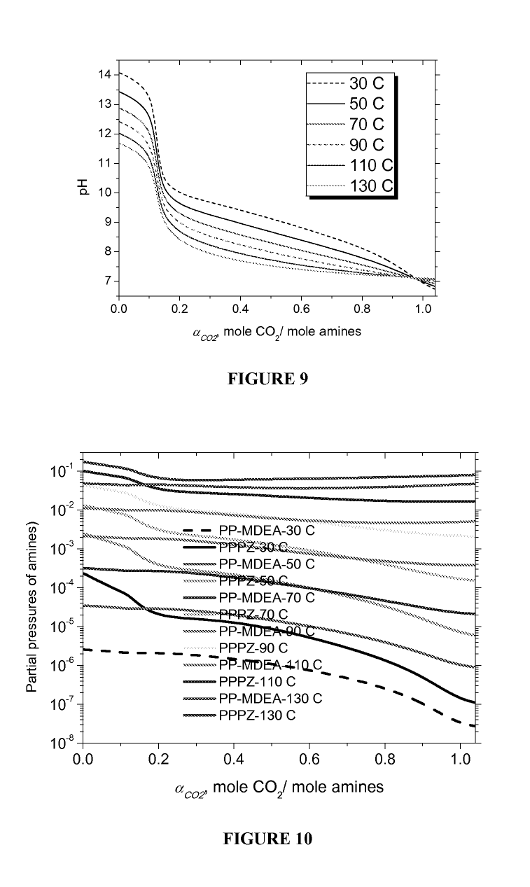

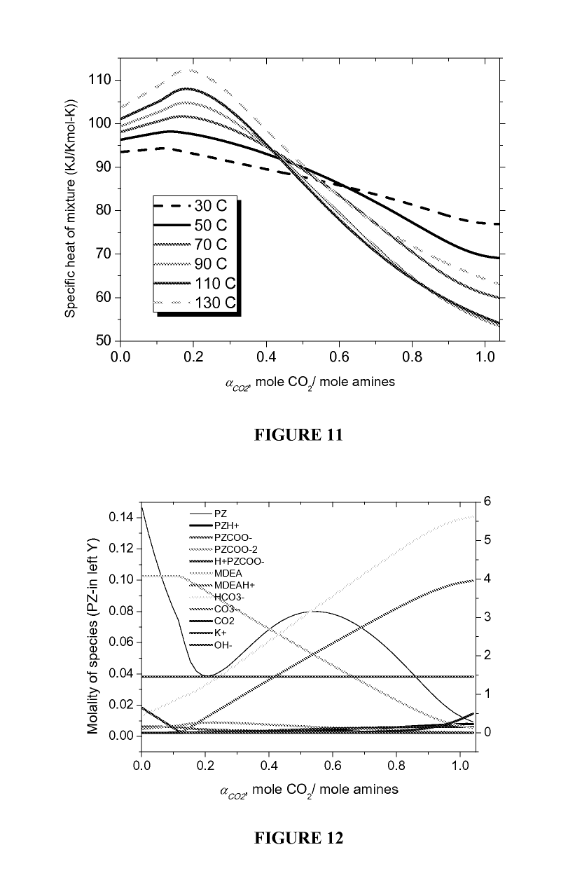

Electrolyte-NRTL model is developed to describe the (Vapour+Liquid) equilibria (VLE) of CO₂ in aqueous (MDEA+K₂CO₃—KHCO₃+PZ) solution. The electrolyte-NRTL model predicted different thermodynamic properties for the system (CO₂+MDEA+K₂CO₃—KHCO₃+PZ+H₂O) and are presented in table 6 and 7 and from FIGS. 3-12.

TABLE 6
ENRTL model predicted solubility of CO₂ in aqueous
(4.081m MDEA + 0.653 m K₂CO₃ + 0.147 m KHCO₃ + 0.408m PZ)
in the temperature range of (313 333) K. α_{CO}_{₂} is defined as mole
CO₂/mole amine (MDEA + K₂CO₃ + KHCO₃ + PZ)

| | | |
|---|---|---|
| T = 313 K | T = 323 K | T = 333 K |

| α_{CO}_{₂} | p_{CO}_{₂}/kPa | α_{CO}_{₂} | p_{CO}_{₂}/kPa | α_{CO}_{₂} | p_{CO}_{₂}/kPa |
|---|---|---|---|---|---|
| 0.134 | 0.084 | 0.134 | 0.138 | 120.519 | 0.229 |
| 0.153 | 0.248 | 0.153 | 0.417 | 0.153 | 0.698 |
| 0.172 | 0.426 | 0.172 | 0.738 | 0.172 | 1.263 |
| 0.191 | 0.616 | 0.191 | 1.095 | 0.191 | 1.913 |
| 0.210 | 0.817 | 0.210 | 1.487 | 0.210 | 2.650 |
| 0.229 | 1.034 | 0.229 | 1.920 | 0.229 | 3.480 |
| 0.248 | 1.271 | 0.248 | 2.402 | 0.248 | 4.418 |
| 0.267 | 1.535 | 0.267 | 2.944 | 0.267 | 5.484 |
| 0.286 | 1.833 | 0.286 | 3.561 | 0.285 | 6.700 |
| 0.304 | 2.173 | 0.304 | 4.265 | 0.304 | 8.091 |
| 0.323 | 2.563 | 0.323 | 5.074 | 0.323 | 9.685 |
| 0.342 | 3.014 | 0.342 | 6.005 | 0.342 | 11.512 |
| 0.361 | 3.536 | 0.361 | 7.077 | 0.361 | 13.605 |
| 0.380 | 4.141 | 0.380 | 8.312 | 0.380 | 15.998 |
| 0.399 | 4.841 | 0.399 | 9.732 | 0.399 | 18.729 |
| 0.418 | 5.653 | 0.418 | 11.363 | 0.418 | 21.835 |
| 0.438 | 6.444 | 0.438 | 13.149 | 0.437 | 25.360 |
| 0.458 | 7.630 | 0.456 | 15.155 | 0.456 | 29.347 |
| 0.477 | 8.724 | 0.478 | 17.576 | 0.475 | 33.846 |
| 0.496 | 9.968 | 0.495 | 19.576 | 0.493 | 38.908 |
| 0.514 | 11.289 | 0.517 | 22.249 | 0.512 | 40.591 |
| 0.532 | 12.785 | 0.532 | 24.627 | 0.531 | 44.958 |
| 0.552 | 14.691 | 0.552 | 27.615 | 0.550 | 45.219 |
| 0.570 | 16.457 | 0.570 | 30.966 | 0.569 | 51.407 |
| 0.589 | 18.204 | 0.589 | 34.303 | 0.588 | 58.312 |
| 0.606 | 20.393 | 0.608 | 38.427 | 0.607 | 66.015 |
| 0.625 | 22.558 | 0.626 | 42.507 | 0.626 | 74.611 |
| 0.645 | 25.631 | 0.645 | 47.547 | 0.645 | 84.212 |
| 0.664 | 29.524 | 0.664 | 54.145 | 0.664 | 94.951 |
| 0.683 | 34.015 | 0.683 | 61.637 | 0.683 | 106.988 |
| 0.701 | 39.216 | 0.701 | 70.171 | 0.701 | 120.519 |
| 0.720 | 45.265 | 0.720 | 79.928 | 0.720 | 135.786 |
| 0.739 | 52.336 | 0.739 | 91.139 | 0.739 | 153.088 |
| 0.758 | 60.657 | 0.758 | 104.096 | 0.758 | 172.797 |
| 0.777 | 70.526 | 0.777 | 119.177 | 0.777 | 195.384 |
| 0.796 | 82.344 | 0.796 | 136.879 | 0.796 | 221.442 |
| 0.815 | 96.653 | 0.815 | 157.856 | 0.815 | 251.720 |
| 0.834 | 114.210 | 0.834 | 182.984 | 0.834 | 287.167 |

TABLE 7
Comparison of VLE (P_{CO2} Vs Loading) for different solvents at 40° C.
and at 5 kPa of CO₂ partial pressure at absorber condition.

| | | | P—CO₂ = 5 kPa, |
|---|---|---|---|
| | Composition | Loading | T = 40 C. |
| H₂O + MDEA | 30 wt % MDEA | 0.38 | Mol CO₂/mol Amine |
| H₂O + MDEA + | 7.9m MDEA + | 0.36 | Mol CO₂/mol Amine |
| PZ | 1.19 m PZ | | |
| | (4M MDEA + | | |
| | 0.6M PZ) | | |
| PZ + H₂O | 3.2M PZ | 0.793 | Mol CO₂/mol Amine |
| H₂O + K₂CO₃ | 30 wt % K₂CO₃ | 0.45 | Mol CO₂/mol K₂CO₃ |
| | (=6.2m K⁺) | 0.225 | Mol CO₂/mol K⁺ |
| APBS1 | MDEA = 30 wt % | 0.401 | Mol CO₂/mol |
| (total 38.7 wt %) | PZ = 2.5 wt % | | (Amine + K⁺) |
| or (5.48m, | K₂CO₃ = 5.5 wt % | | |
| Mol/kg water) | KHCO₃ = 0.9 wt % | | |

e) Heat of Absorption for MDEA-PZ-K₂CO₃—KHCO₃—H₂O Blend

The heat of absorption of CO₂ into a solvent is an important parameter, since it gives magnitude of heat released during the absorption process. Besides, it represents the energy required in the regenerator to reverse the reaction and release CO₂ from the solvent. The differential heat of absorption of CO₂ into (4.081 m MDEA+0.653 m K₂CO₃+0.147 m KHCO₃+0.408 m PZ) solvent is estimated from the ENRTL model based on the Clausius-Clapeyron equation:

$$\frac{- Δ {H}_{abs}}{R} = \frac{d ln {P}_{{CO}_{2}}}{d ( 1 / T )}$$

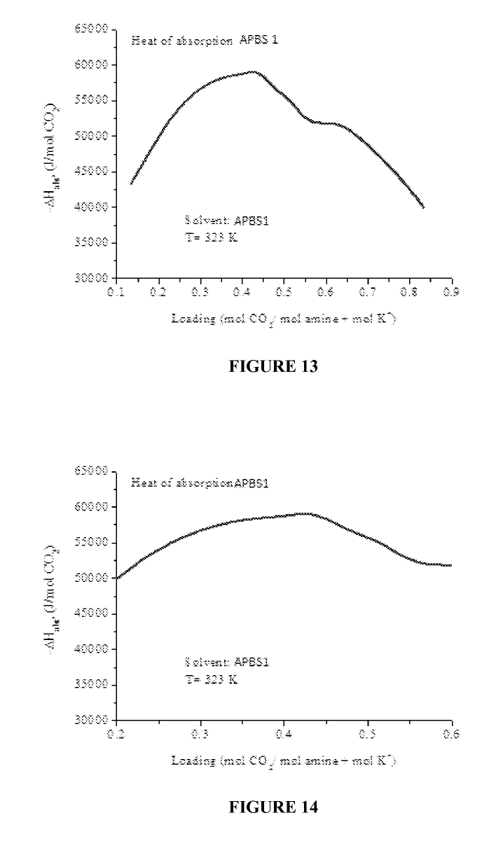

FIG. 13 and FIG. 14 shows the calculated heat of absorption for (4.081 m MDEA+0.653 m K₂CO₃+0.147 m KHCO₃+0.408 m PZ) solvent at 323 K as a function of CO₂ loading. The AH_{abs} is estimated to be around 56 kJ/mol CO₂ by taking an average value between loading 0.2 to 0.6.

### EXAMPLE 3

### CO₂-MDEA-MPZ-K₂CO₃—KHCO₃—H₂O System

The CO₂ reaction with promoted amines/carbonate blend is investigated over the ranges in temperature, 298 to 308 K, and MPZ concentrations, 0.15 to 0.45 M. The concentrations of MDEA, K₂CO₃ and KHCO₃ in solution are 2.5, 0.4 and 0.09 M, respectively. This reaction system belongs to the fast reaction regime systems.

a) Estimation of Physical Properties for MDEA-MPZ-K₂CO₃—KHCO₃—H₂O Blends

Knowledge on physical properties is essential for the estimation of reaction kinetics. The density and viscosity of the blend comprising MDEA, K₂CO₃/KHCO₃, promoter (methyl piperazine) and H₂O were measured at 298, 303 and 308.

MIX*=MDEA (2.5 M), KHCO₃ (0.09M), K₂CO₃ (0.4 M) and n-Methyl Piperizine

TABLE 8
Density (ρ), Viscosity (μ) and Diffusivity Data (D_{CO2}) for MIX* at
different methyl Piperazine concentration at 298, 303 and 308 K

| T | MPZ Conc. | ρ | μ | D_{CO}_{₂} × 10⁹ |
|---|---|---|---|---|
| (K) | (M) | (kg/m³) | (kg/(m · s)) | (m²/s) |
| 298 | Mix + 0.15 | 1066.35 | 1.70 | 1.20 |
| | Mix + 0.25 | 1074.04 | 1.74 | 1.18 |
| | Mix + 0.35 | 1081.61 | 1.80 | 1.15 |
| | Mix + 0.45 | 1088.85 | 1.84 | 1.13 |
| 303 | Mix + 0.15 | 1065.87 | 1.37 | 1.48 |
| | Mix + 0.25 | 1073.19 | 1.43 | 1.42 |
| | Mix + 0.35 | 1080.44 | 1.48 | 1.38 |
| | Mix + 0.45 | 1087.04 | 1.54 | 1.34 |
| 308 | Mix + 0.15 | 1064.96 | 1.23 | 1.67 |
| | Mix + 0.25 | 1072.35 | 1.27 | 1.62 |
| | Mix + 0.35 | 1079.07 | 1.30 | 1.60 |
| | Mix + 0.45 | 1086.22 | 1.35 | 1.55 |

b) Reaction Kinetic Data for MDEA-MPZ-K₂CO₃—KHCO₃—H₂O Blends

With increase in temperature & promoter concentration cause the expected increase in the values of the observed reaction rate constants.

TABLE 9
CO₂ absorption rates and values of the observed reaction rate constant
into aqueous mixtures of MDEA (2.5M), MPZ, K₂CO₃ (0.4M) and
KHCO₃ (0.09M) at 298, 303 and 308 K

| Temp. | CO₂ pressure | MPZ | R × 10⁶ | k_{obs} |
|---|---|---|---|---|
| (K) | (kPa) | (M) | (kmol/(m² s)) | (1/s) |
| 298 | 9.5 | 0.15 | 8.70 | 8062 |
| | 5.7 | 0.25 | 5.94 | 8508 |
| | 4.7 | 0.35 | 5.72 | 9253 |
| | 5.7 | 0.45 | 7.78 | 10355 |
| 303 | 7.9 | 0.15 | 7.72 | 8465 |
| | 5.5 | 0.25 | 6.44 | 9053 |
| | 5.76 | 0.35 | 7.60 | 9384 |
| | 5.75 | 0.45 | 8.38 | 10556 |
| 308 | 5.92 | 0.15 | 4.5 | 9940 |
| | 7.02 | 0.25 | 8.33 | 12385 |
| | 4.3 | 0.35 | 6.22 | 14248 |
| | 7.56 | 0.45 | 13.9 | 20246 |

TABLE 10
Effect of MDEA concentration into aqueous mixtures of MDEA,
MPZ (0.25M), K₂CO₃ (0.4M) and KHCO₃ (0.09M) at 303 K

| MDEA | CO₂ Pressure | R × 10⁶ |
|---|---|---|
| (M) | (kPa) | (kmol/(m² s)) |
| 1.5 | 4.9 | 5.22 |
| 2.5 | 5.5 | 6.44 |
| 3.5 | 5.8 | 6.89 |

c) Solubility Data for MDEA-MPZ-K₂CO₃—KHCO₃—H₂O Blends

Solubility of CO₂ in the mixture [MDEA (2.5M)+K₂CO₃ (0.4M)+KHCO₃ (0.0925M)+MPZ]

Knowledge on CO₂ solubility in solution is essential for estimation of reaction kinetics.

TABLE 11
Solubility of CO₂ in the mixture [MDEA (2.5M) + K₂CO₃ (0.4M) +
KHCO₃ (0.0925M) + M-PZ] 298, 303 and 308 K

| T | MPZ Conc. | H_{CO}_{₂} × 10⁴ |
|---|---|---|
| (K) | (M) | [kmol/(m³ · kPa)] |
| 298 | Mix + 0.15 | 2.95 |
| | Mix + 0.15 | 3.30 |
| | Mix + 0.15 | 3.73 |
| | Mix + 0.15 | 3.98 |
| 303 | Mix + 0.15 | 2.76 |
| | Mix + 0.15 | 3.26 |
| | Mix + 0.15 | 3.66 |
| | Mix + 0.15 | 3.87 |
| 308 | Mix + 0.15 | 1.91 |
| | Mix + 0.15 | 2.67 |
| | Mix + 0.15 | 3.03 |
| | Mix + 0.15 | 3.23 |

d) Vapour—Liquid Equilibrium Data for MDEA-MPZ-K₂CO₃—KHCO₃—H₂O Blend

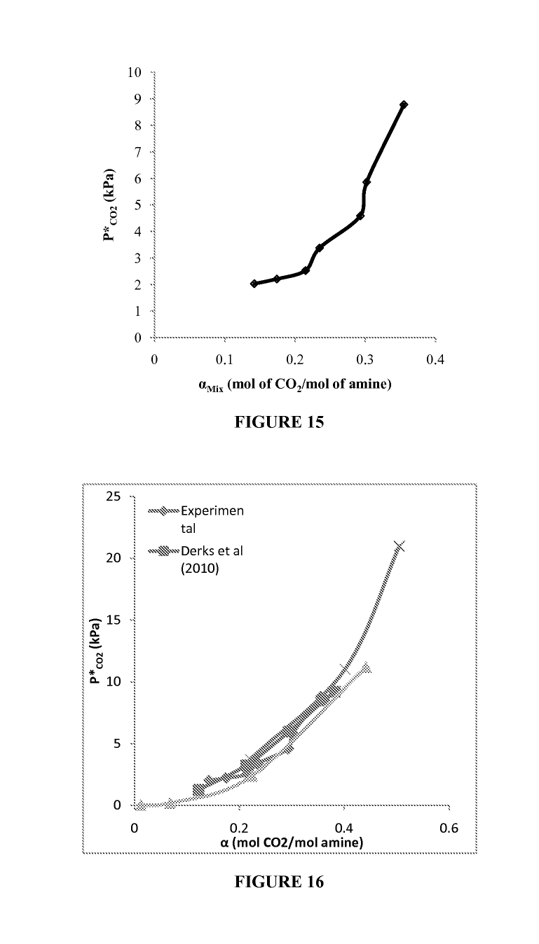

Knowledge of the equilibrium partial pressure of CO₂ over alkanolamine solution is essential, particularly in the design of top portion of absorber. The CO₂ slip in treated gas is mainly depends on equilibrium partial pressure. Under design of absorber will effect on production cost. Therefore, gas-liquid equilibrium data is of importance. See Table 12 and 13 and FIG. 15.

TABLE 12
Equilibrium CO₂ partial pressure over MDEA-MPZ-
K₂CO₃—KHCO₃—H₂O blend. α_{CO}_{₂} is defined as mole CO₂/mole amine
(MDEA + MPZ + KHCO₃ + K₂CO₃) Temperature: 303 K

| α_{Mix} | |
|---|---|
| (mole CO₂/mole | p_{CO}_{₂}* |
| amine) | (kPa) |
| 0.142 | 2.03 |
| 0.174 | 2.21 |
| 0.215 | 2.53 |
| 0.235 | 3.38 |
| 0.293 | 4.59 |
| 0.302 | 5.86 |
| 0.355 | 8.78 |

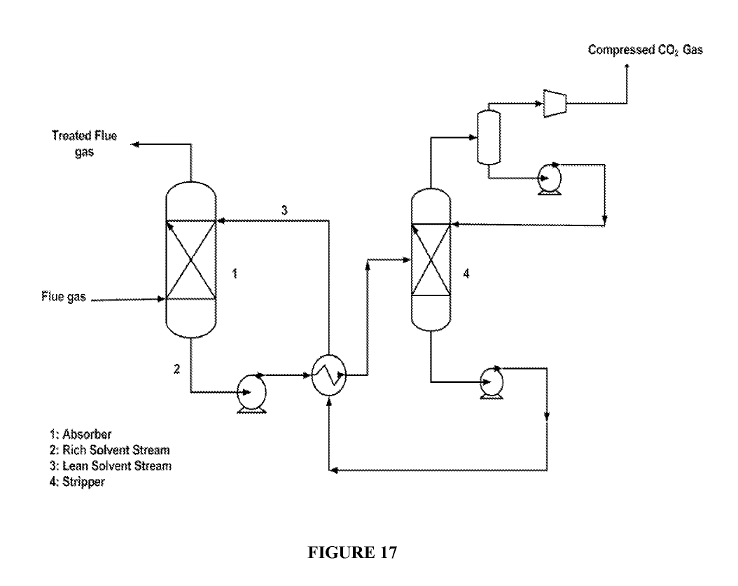

Literature Comparison with (CO₂+MDEA) and (CO₂+MDEA-MPZ-K₂CO₃—KHCO₃). See table 13 and FIG. 16.

TABLE 13

| Derks et al | | Jou et al | | Kundu et al | |
|---|---|---|---|---|---|
| 2010 | | 1982 | | 2006 | |
| α_{Mix} | | α_{Mix} | | α_{Mix} | |
| (mole | | (mole | | (mole | |
| CO₂/mole | p_{CO}_{₂}* | CO₂/mole | p_{CO}_{₂}* | CO₂/mole | p_{CO}_{₂}* |
| amine) | (kPa) | amine) | (kPa) | amine) | (kPa) |
| 0.122 | 1.25 | 0.012 | 0.0132 | 0.22 | 3.7 |
| 0.213 | 3.24 | 0.0676 | 0.184 | 0.401 | 11 |
| 0.294 | 5.97 | 0.224 | 2.38 | 0.505 | 21 |
| 0.361 | 8.5 | 0.441 | 11.2 | — | — |
| 0.382 | 9.2 | — | — | — | — |

The obtained experimental vapour—liquid data is in good agreement with previously published research articles.

### EXAMPLE 4

### Efficiency of the Solvent Systems in Comparison with the Conventional Solvent System

The present example illustrates the results of solvents tested on Promax, a simulation software licensed by Bryan Research and Engineering with conventional carbon capture process configuration.

The conventional process has an absorber operating at 1 atm. The flue gas enters at 46° C. and 1 atm and comes in contact with lean solvent from the stripper. The bottom stream leaving the absorber known as rich solvent enters the cross exchanger which has a temperature approach of 5° C. and enters the stripper. The stripper operates at 100-120° C. and 2 atm for different solvents. The stream leaving from top of the stripper is cooled and condensed to remove the water present in the strip gas. Thus condenser's top stream is compressed to 2.97 atm to achieve 90% carbon dioxide recovery with 99% (% wt) purity. FIG. 17 shows a process flow diagram of conventional carbon capture system

TABLE 14
APBS Solvent Composition

Composition

| Solvents | MDEA | PZ | K⁺ | Water |
|---|---|---|---|---|
| APBS1 | 29.1 | 2.1 | 4.89 | 36.09 |
| APBS2 | 38.25 | 6.75 | 5 | 50 |
| APBS3 | 30 | 6.75 | 13.25 | 50 |
| APBS4 | 50 | 6 | 15 | 29 |

The above chart shows that ABPS2, ABPS3 and APBS4 have less steam demand with respect to other solvents. The above chart shows that ABPS2, ABPS3 and ABPS4 have comparable recirculation rate to existing solvents

Results:

Following are results which are derived from simulation on above process configuration

TABLE 15

| | | | 41.6 (wt %) | | |
|---|---|---|---|---|---|
| | | | MDEA & | 50 (% wt) | 7.95 (wt %) |
| | | 30 (% wt) | 8.58 (wt %) | MDEA & | K+ & 3.96 |
| Parameters | Units | MEA | PZ | 5% wt PZ | (wt %) PZ |
| Steam Demand | kg of steam/ | 1.76 | 1.88 | 1.49 | 4.42 |
| | kg of CO₂ | | | | |
| Lean solvent flowrate | kg/h | 168.26 | 160.02 | 346.84 | 1013.2 |
| Lean solvent loading | mol/mol | 0.22 | 0.018 | 0.077 | 0.56 |
| Rich solvent flowrate | kg/h | 173.19 | 166.1 | 357.01 | 1023.78 |
| Rich solvent loading | mol/mol | 0.53 | 0.38 | 0.23 | 0.7 |
| CO₂ capture Auxiliary | W | 19.47 | 21.35 | 41.62 | 117.76 |
| loads | | | | | |
| CO₂ compressor | W | 201.75 | 277.69 | 181.15 | 200.7 |
| auxiliary loads | | | | | |
| Total auxiliary loads | W | 221.22 | 299.04 | 222.77 | 318.46 |
| Cooling water duty | kW | 7.15 | 9.02 | 9.3 | 28.66 |
| Total steam duty | kW | 11.88 | 12.95 | 10 | 29.8 |

TABLE 16

| Parameters | Units | APBS1 | APBS2 | APBS3 | APBS4 |
|---|---|---|---|---|---|
| Steam Demand | kg of | 3.76 | 1.41 | 1.3 | 1.16 |
| | steam/ | | | | |
| | kg of CO₂ | | | | |
| Lean solvent flowrate | kg/h | 1888 | 301.19 | 297.02 | 277.29 |
| Lean solvent loading | mol/mol | 0.22 | 0.21 | 0.38 | 0.32 |
| Rich solvent flowrate | kg/h | 1899 | 311.53 | 308.08 | 290.43 |
| Rich solvent loading | mol/mol | 0.26 | 0.387 | 0.543 | 0.45 |
| CO₂ capture | W | 217.07 | 34.09 | 30.46 | 27.06 |
| Auxiliary loads | | | | | |
| CO₂ compressor | W | 190.63 | 184.86 | 182.64 | 178.72 |
| auxiliary loads | | | | | |
| Total auxiliary loads | W | 407.7 | 218.95 | 213.1 | 205.78 |
| Cooling water duty | kW | 25.25 | 8.91 | 8.56 | 8.86 |
| Total Reboiler duty | kW | 25.4 | 9.7 | 8.8 | 7.8 |

The above result is a detailed comparison of various solvents simulated on conventional system using Promax. The proposed APBS solvent shows lower steam demand in comparison to other existing solvent or combination of solvents. The steam used in reboiler in all the above cases is at 4.4 atm and 151° C. The recirculation rate i.e. lean solvent flow rate is illustrated in the above table. Due to decreased lean solvent flowrate the power requirement of pump i.e. auxiliary load is also lower for ABPS2, APBS3 and ABPS4. Thus overall power requirement for entire carbon capture and compressing of CO₂ goes down. The steam demand is also less in case of APBS solvent hence the total steam duty is also less for ABPS2, APBS3 and ABPS4. The cooling water duty is higher only in APBS1 while in ABPS2, APBS3 and APBS4 is lower in comparison to other solvents.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-6. (canceled)

7. A solvent for recovery of carbon dioxide from gaseous mixture, comprising:
amine,
a promoter, and
a carbonate buffer,
wherein the solvent contains less than about 75% by weight of water.

8. The solvent as claimed in claim 1, wherein the carbonate buffer is a potassium carbonate buffer.

9. The solvent as claimed in claim 1, wherein the promoter is 2% and 18% wt percent.

10. The solvent as claimed in claim 1, wherein the amine is a sterically hindered amine.

11. The solvent as claimed in claim 1, wherein the amine is an alkanolamine.

12. The solvent as claimed in claim 1, wherein the promoter is piperazine or a piperazine derivative.

13. The solvent as claimed in claim 1, wherein the promoter is a di-amine.

14. The solvent as claimed in claim 5, wherein the alkanolamine is N-methyldiethanolamine (MDEA).

15. The solvent as claimed in claim 1, wherein the promoter is greater than 6% by weight and buffers the solution to a pH of between about 12 and 14 in the absence of CO2.

16. The solvent as claimed in claim 1, wherein the solvent has a pH of less than 12 in the presence of CO2.

17. The solvent as claimed in claim 1, wherein the solvent contains less than about 65% by weight of water.

18. The solvent as claimed in claim 1, wherein the amine is selected from group comprising N-methyldiethanolamine (MDEA), 2-(2-aminoethoxy)ethanol, Aminoethylethanolamine (AEEA), 2-amino-2methyl-1-proponal (AMP), 2-(ethyamino)-ethanol (EAE), 2-(methylamino)-ethanol (MAE), 2-(diethylamino)-ethanol (DEAE), diisopropanolamine (DIPA), methylaminopropylamine (MAPA), 3-aminopropanol (AP), 2,2-dimethyl-1,3-propanediamine (DMPDA), 3-amino-1-cyclohexylaminopropane (ACHP), diglycolamine (DGA), 1-amino-2-propanol (MIPA), 2-methyl-methanolamine (MMEA), diethyl ethanol amine or any combinations thereof at concentration ranging from about 10 wt % to about 40 wt %. The solvent as claimed in claim 1, wherein the promoter is selected from group comprising piperazine, N-aminoethylpiperazine (AEP), N-methylpiperazine, 2-methylpiperazine, 1-ethylpiperazine, 1-(2-hydroxyethyl) piperazine, 2,5-dimethylpiperazine , 1-Amino-4-Methyl Piperazine and any combinations thereof.

19. The solvent as claimed in claim 1, wherein the carbonate buffer is selected from a group comprising potassium carbonate, sodium carbonate salt, lithium carbonate, a carbonate salt, a bisulfide salt, hydroxide salt and any combination thereof.

20. The solvent as claimed in claim 1, wherein the amine has concentration between about 10 wt % and 40 wt %.

21. A method for removing CO2 from a stream, comprising the steps of:
(a) contacting the stream with a solvent having components amine, promoter, and a carbonate buffer, wherein the solvent contains less than about 75% by weight of water,
(a) allowing the solvent to absorb CO2 at a temperature, and
(b) regenerating the solvent from heating the solvent greater than 80 C, wherein the stream has a temperature between 40 C to 65 C, and the regeneration is under a pressure between about 0.01 and 10 bar.

22. The method as claimed in claim 15, wherein the amine is hindered amine.

23. The method as claimed in claim 15, wherein the solvent has a temperature between about 30 0 C and 140 0 C.

24. The method as claimed in claim 15, wherein the absorption is under a pressure between about 1 and 30 bar.

25. The method as claimed in claim 15, wherein the solvent is regenerated at a temperature between 80 0 C and 140 0 C.

26. A process for dissolving carbon dioxide in a solvent, comprising:
(a) providing a stripper having an upper section and a bottom section,
(b) supplying the solvent to the upper section and the bottom section, wherein the bottom section is supplied more of the solvent then the upper section,
(c) heating the solvent to the upper section using the heat contained in carbon dioxide liberated from the bottom section of the stripper and the bottom section, and
(d) providing solvent filter for removing the degraded solvents from the solvent.
